(19) United States
(12) Patent Application Publication
(10) Pub. No.: US 2010/0237991 A1
(43) Pub. Date: Sep. 23, 2010

(54) BIOMETRIC SCANNING ARRANGEMENT AND METHODS THEREOF

(76) Inventors: Krishnanand Prabhu, Bangalore (IN); Harisha Mallegowda, Bangalore (IN); Ravishankar Margad Shivashankar, Watford (GB); Devanshu Kant, San Diego, CA (US)

Correspondence Address: KYOCERA INTERNATIONAL INC.;INTELLECTUAL PROPERY DEPARTMENT, P.O. BOX 928289, SAN DIEGO, CA, 92192, US

(21) Appl. No.: 12/406,030

(22) Filed: Mar. 17, 2009

(51) Int. Cl. G06F 7/04

(52) U.S. Cl. 340/5.83; 382/124

(57) ABSTRACT

A method for employing a biometric scanning arrangement to manage a set of actions performed on a mobile device is provided. The method includes setting the biometric scanning arrangement to a mode, wherein the mode including at least one of a navigation mode and a matching mode. The method also includes capturing an image of a unique physiological feature, wherein the capturing is performed by a biometric sensor. The method further includes performing the set of actions associated with the image for the mode, wherein the set of actions is other than authentication of a user possessing the unique physiological feature.

### FIELD OF THE INVENTION

The invention relates to biometric sensor for use in electronic devices.

### BACKGROUND OF THE INVENTION

Mobile telephones have long been employed to facilitate communication between users who are geographically dispersed. In recent years, some mobile telephones have evolved into smart devices as additional functionalities, besides telecommunication, have been added. In an example, new functionalities that may be added include, but are not limited to, text message functionality, email functionality, Internet functionality, game functionality, Bluetooth functionality, camera functionality, and the like.

To facilitate discussion, FIG. 1 shows a simple diagram of a mobile telephone 100. Mobile telephone may include a keypad area 102 and a display screen 104. Keypad area 102 may include alphanumeric keys, hotkeys, and navigation keys.

Generally, most mobile telephones have alphanumeric keys, such as the keys shown in section 106. By utilizing alphanumeric keys 106, a user of mobile telephone 100 may be able to enter telephone numbers, type text messages, enter web page addresses, and the like.

Some mobile telephones may have preprogrammed keys, such as hotkeys 108 and 110, which allow the user of the mobile telephone to quickly activate one or more functions, such as initiate the camera function (110) of a mobile telephone, for example.

Navigation keys, such as keys 112u, 112d, 112r, 112l, and 112s, allow the user of mobile telephone 100 to maneuver between functionalities that may be shown on display screen 104. Navigation keys may also be employed to select functionality. In an example, to select the contact list, the user may press twice on the 112r key to move from the message icon (114) to the contact list (116). Once the user has highlighted the contact list (116), the user may press the 112s key to select the contact list (116).

In order to reduce the number of steps a user may have to take in order to activate a commonly utilized function, some mobile telephones may allow the user to program a specific function to a specific key. In an example, speed dialing is a common functionality that is enabled in many mobile telephones. With speed dialing, the user of a mobile telephone may map a specific telephone number to a specific alphanumeric key. In an example, if the user wants to call his friend Jake, the user has the option of entering Jake's telephone number or looking him up in the contact list. However, if the user has utilized the speed dialing option to set his friend Jake's telephone number to alphanumeric key 2, the user may press alphanumeric key 2 to quickly call his friend.

Although the hotkey and/or preprogrammed keys may reduce the number of steps a user may have to enter to access a function, there are several disadvantages. For example, the functions associated with the hotkey/preprogrammed keys may be unintentionally activated when the hotkey/preprogrammed keys are accidentally pressed. In an example, Jake's telephone number may be unintentionally dialed when a child accidentally presses the alphanumeric key 2 while playing with his parent's mobile telephone. In another example, the hotkey/preprogrammed keys may be accidentally pressed when another object is pressing against the keys. For example, a mobile telephone is kept in a purse. Other objects, also stored within the purse, may press against the mobile telephone and accidentally activate one of the hotkey/preprogrammed keys.

To prevent the hotkey/preprogrammed keys from being unintentionally activated, the user may have to lock the keypad of the mobile telephone. Once locked, the user is usually unable to activate the hotkey/preprogrammed keys without first having to unlock the keypad. Since each mobile telephone may vary, the user may have to remember the function for unlocking the keypads of the mobile telephone. During an emergency, a locked keypad may cause the user to become frustrated, especially if the user is unable to remember the steps for unlocking the keypad.

Besides hotkey/preprogrammed keys, a user may also employ voice command to perform certain functions, such as speed dialing, on a mobile telephone. In an example, the user may train the mobile telephone to accept a set of words, such as “JAKE”, to dial telephone numbers. Unfortunately, voice command may be limited since voice command usually is not very effective if the user's voice has changed. In an example, the user's voice may change when he has a cold. As a result, the user may find it quite frustrating to employ voice command while he is sick. In another example, the user may be unable to employ voice command in a noisy area (e.g., a store, the ballpark, the airport, etc.) since the mobile telephone may not be able to differentiate the voice command provided by the user from the other noises within the vicinity. As a result, many users of mobile telephones have found voice command to have limited application.

### SUMMARY

The invention relates, in an embodiment, to a method for employing a biometric scanning arrangement to manage a set of actions performed on a mobile device. The method includes setting the biometric scanning arrangement to a mode, wherein the mode including at least one of a navigation mode and a matching mode. The method also includes capturing an image of a unique physiological feature, wherein the capturing is performed by a biometric sensor. The method further includes performing the set of actions associated with the image for the mode, wherein the set of actions is other than authentication of a user possessing the unique physiological feature.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a simple diagram of a mobile telephone.

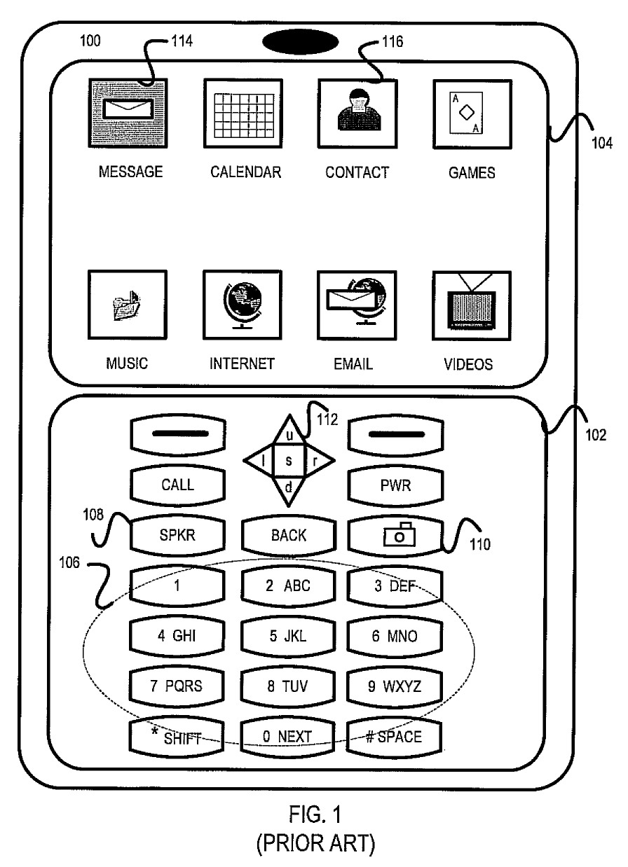

FIG. 2 shows, in an embodiment of the invention, a partial view of a mobile device, representing an example mobile device within which the inventive biometric scanning arrangement may be implemented.

FIG. 3 shows, in an embodiment of the invention, a simple flow chart illustrating the steps for enrolling and mapping a unique physiological feature to one or more functions.

FIG. 4 shows, in an embodiment of the invention, a simple database for storing biometric related data.

FIG. 5A shows, in an embodiment, a simple flow chart illustrating the steps to authenticate a user.

FIG. 5B shows, in an embodiment of the invention, a simple flow chart illustrating the steps for performing speed dialing.

FIG. 5C shows, in an embodiment of the invention, a simple flow chart illustrating the steps for handling situations under which more than one function may be associated with a single physiological feature.

FIG. 6 shows, in an embodiment of the invention, a simple block diagram illustrating the mode status of a mobile device.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

In recent years, biometric sensor has gained popularity as an authentication tool. Biometric sensor may be employed to scan one or more unique physiological feature of a human. Examples of unique physiological features that may be employed in biometric measurements may include fingerprints, iris of an eye, hand geometry, face recognition, and the like.

For example, in some high-level security building, biometric sensors (such as iris scanners, fingerprint readers, and the like) may be employed to authenticate a person before allowing a person entry into a secured area. In other words, the person's unique feature, such as a person's iris may be scanned and a biometric template (e.g., minutiae patterns) of the person's unique feature is stored. Those skilled in the art are aware that the biometric template is usually created by extracting specific features of the unique feature.

When the person tries to access the secured area with his iris, the biometric sensor scans the person's iris and compares the scanned pattern of the iris against the biometric templates stored within the database. If the person's iris matches a biometric template stored within the database, the person seeking entry is allowed to enter the secured area.

More recently, biometric sensors have been integrated as part of a computer security system. In an example, instead of securing his computer with a password, a user may scan his fingerprint. The scanned pattern of the fingerprint is saved in a database as a biometric template. When a user tries to access the computer, the biometric sensor may compare the scanned fingerprint against the saved fingerprint. The user is only allowed access to the computer if the fingerprints match.

The inventors herein realized that since the biometric sensor is capable of scanning and saving the scanned pattern, the biometric sensor may be configured to not only perform authentication but also to perform other functions that may be supported by the mobile devices. In accordance with embodiments of the invention, a biometric scanning arrangement and methods thereof are provided. Embodiments of the invention include integrating a biometric scanning arrangement as an authentication tool for preventing unauthorized access to a mobile device. Embodiments of the invention also include enabling the biometric scanning arrangement to perform navigation. Further, embodiments of the invention include enabling the biometric scanning arrangement to perform varied functions

In this document, various implementations will be discussed using swiping as an example. This invention, however, is not limited to swiping a unique physiological feature across a biometric sensor and may be applied to other method of presenting a unique physiological feature to the biometric sensor (such as pressing). Instead, the discussions are meant as examples and the invention is not limited by the examples presented.

In one or more embodiments of the invention, a biometric sensor is integrated as hardware on a mobile device (e.g., mobile telephones, personal digital assistants, Internet tablets, and the like). The biometric sensor may be employed as an authentication tool, in an embodiment. In an example, the owner of the mobile device may scan his right thumb. The biometric sensor may capture an image of the right thumb print and store the image inside a database. Those skilled in the art are aware that the image captured by the biometric sensor does not usually include an exact replica of the unique physiological feature. Instead, the biometric sensor usually extracts certain features of the unique biometric feature to create a biometric template (e.g., minutiae patterns). To access the mobile device, the user presents (e.g., swipes, presses, etc.) his right thumb to the biometric sensor. The scanned pattern may be compared against a database of stored biometric templates, in an embodiment. The user is allowed access to the mobile device if a match is identified.

By integrating the biometric sensor into a mobile device, such as a mobile telephone, unauthorized users may be prevented from accessing the mobile devices. Consider the situation wherein, for example, Charlie has a mobile telephone. However, Charlie has misplaced his mobile telephone. In the prior art, if Charlie fails to notify his cellular service about his loss in a timely manner, Charlie may become responsible for any charges that may be incurred. In some instances, owners of lost mobile telephones have found themselves responsible for telephone charges that may cost thousands of dollars.

However, with the biometric scanning arrangement, Charlie is protected from unauthorized utilization of his mobile telephone since his mobile telephone is not accessible without Charlie's right thumb print. Thus, the biometric sensor as an authentication tool substantially eliminates unauthorized usage of the mobile device. Further, the biometric sensor protects sensitive data (such as telephone numbers, addresses, pictures, and the like) from unauthorized users.

Since the biometric sensor is a hardware that needs to be accessible to the user of the mobile device, the biometric sensor has to be allotted space on the physical surface of the mobile device. Usually, space on a mobile device is of high premium since most manufacturers try to minimize the size of the mobile device to meet consumer's demand for portability. Without increasing the size of the mobile device, the manufacturers may have to decrease the size of the keys on the mobile device. However, if the keys become too small, the mobile device may not be appealing since users may have a hard time manipulating the keys.

Another possibility may include removing one or more hardware that may not be needed. Since the biometric sensor is capable of reading movements, the biometric sensor may be programmed to behave as a navigation tool, in an embodiment. For example, in the prior art, a user of a mobile telephone may press a left arrow navigation key in order to move the cursor toward the left, press an up arrow navigation key to move the cursor upward, and the like. With a biometric sensor, the user may swipe his finger in the direction he wants the cursor to be moved to direct the cursor. In an example, the user may swipe his finger to the right in order to move the cursor to the right and swipe his finger upward to move the cursor upward. In addition, the user may tap his finger on the biometric sensor to make a selection and/or the user may perform a double tap to open an application. As a result, the set of navigation keys that are commonly found on mobile devices may be eliminated since the biometric sensor is capable of performing the same function as the set of navigation keys. Thus, adding the biometric sensor required no additional real estate to be allotted on the mobile device since the biometric sensor may replace the set of navigation keys.

The ability for the manufacturer to offer authentication and navigation with a single hardware (i.e., biometric sensor) enables the manufacturer to provide the consumers with a product that not only offer more user's protection against unauthorized access but also provide the user of the mobile device a more intuitive navigational tool without having to sacrifice precious real estate space on the mobile device. As can be appreciated from the foregoing, not having to increase the size of the mobile device enables the manufacturer to provide a more desirable product to the consumers who are interested in more functionality without sacrificing form.

In one or more embodiments of the invention, the biometric sensor may be employed as a tool for manipulating application software of a mobile device. Since the biometric sensor is already configured to capture and store the biometric template of a unique physiological feature of a person, the inventors herein realized that since a person may have more than one unique physiological feature, each of the unique physiological features may be scanned and mapped to perform specific function. In an example, the biometric sensor may be employed to capture biometric template of unique physiological features, such as fingerprints. The biometric template of each fingerprint, for example, may be stored within a database and mapped to specific function, such as launching the web browser, for example

In an embodiment, the saved biometric template of one or more unique physiological feature may be utilized to perform speed dialing. In an example, the fingerprint of the right index finger may be saved as a biometric template. Once the fingerprint has been captured, the fingerprint biometric template may be mapped to a specific telephone number, thereby allowing the user of the mobile telephone to perform speed dialing by swiping his right index finger across the biometric sensor. As can be appreciated from the foregoing, the fingerprint of each finger may be mapped to a unique telephone number. Unlike the prior art, the chance of a telephone number being unintentionally dialed is minimized, since a misdialed number due to a person (e.g., child) or an object accidentally performing a speed dial function call by pressing against a designated key is substantially eliminated.

Advantageously, the ability to activate a function by presenting a unique physiological feature (such as swiping a finger, for example) to a biometric sensor enables mobile devices, such as mobile telephones, to become accessible to people who may have previously been unable to enjoy the benefit offers by the small mobile devices due to the small size of the hardware, such as the keys. In an example, visually impaired people may be unable to see the tiny lettering on the small keys of the mobile device. As a result, the visually impaired people may not be able to perform simple tasks (such as dialing a telephone number) since the visually impaired people may not be able to read the lettering on the keys. In another example, people who suffer from tremble may be unable to manipulate the small keys. These people may become frustrated each time a task (such as dialing a telephone number) requires the small keys to be pressed. For example, since the keys are small and are closely positioned to one another, people who suffer from tremble may end up pressing the wrong key, such as a neighboring key. These are but a few examples of the limitation of the mobile devices. However, by programming biometric sensor to accept unique physiological features as commands for performing certain functions, physically challenged individuals are no longer prevented from enjoying the benefits that a mobile device may provide.

In an embodiment of the invention, the biometric scanning arrangement is enabled even though the keypad of a mobile device may be locked. In an embodiment, the biometric scanning arrangement is enabled for all functions that may be mapped to a unique physiological feature regardless if the keypad of a mobile device is locked. In other words, a user of the mobile device may still perform speed dialing by presenting a unique physiological feature, such as swiping his finger, to the biometric sensor even though he may have locked the keypad of his mobile device.

In another embodiment, the biometric scanning arrangement provides for emergency function(s) to be performed. In an example, the right index finger may be mapped to “911”. Even if the user has locked his mobile device, the user is still able to make emergency calls with a swipe of his right index finger, for example, With the biometric scanning arrangement, a user may be able to make emergency call without having to worry about first unlocking his mobile device.

Besides speed dialing, other functions may be mapped to a unique physiological feature. In an example, the left little finger may be mapped to launch the contact list. In another example, the left index finger may be mapped to launch the web browser. The types and numbers of functions that may be available may vary depending upon the mobile device.

In an embodiment, a unique physiological feature may be mapped to more than one function. If a unique physiological feature is associated with more than one function, context may be associated with the function to enable the system to identify which functions should be performed. Consider the situation wherein, for example, the user has mapped the left index finger to dial John's telephone number (within the main menu context) and to launch the web browser (within the start menu context) If John's mobile device is currently within the main menu, then the system is programmed to perform the function that is associated with the main menu context, which is speed dialing in this example.

In an embodiment of the invention, the biometric scanning arrangement is configured to store a plurality of profiles. Consider the situation wherein, for example, Jim and Mary share a mobile telephone. In order to enable both to access the mobile telephone, both Jim and Mary may each create a profile. The biometric templates associated with the unique physiological features for each person are stored under the person's profile.

In an embodiment, a person is required to be authenticated before the biometric sensor may be employed to navigate within the mobile device and/or manage applications stored within the mobile device. In an example, once Jim has authenticated by swiping his finger against the biometric sensor, the system may access Jim's profile each time Jim employs the biometric sensor to navigate or manage the software applications on the mobile device.

In another embodiment, only one user is required to be authenticated. In an example, Jim has provided the proper authentication to access the mobile device. Once Jim has access the mobile telephone, the mobile telephone is configured to accept any command that is associated with any biometric templates stored within the database. In other words, Mary may utilize the biometric scanning arrangement to manipulate software application since Mary has a profile saved on the mobile device. As can be appreciated from the foregoing, the methods for accessing a mobile device given a plurality of profiles may vary depending upon manufacturer's preference and/or user's settings.

The features and advantages of the present invention may be better understood with reference to the figures and discussions that follow.

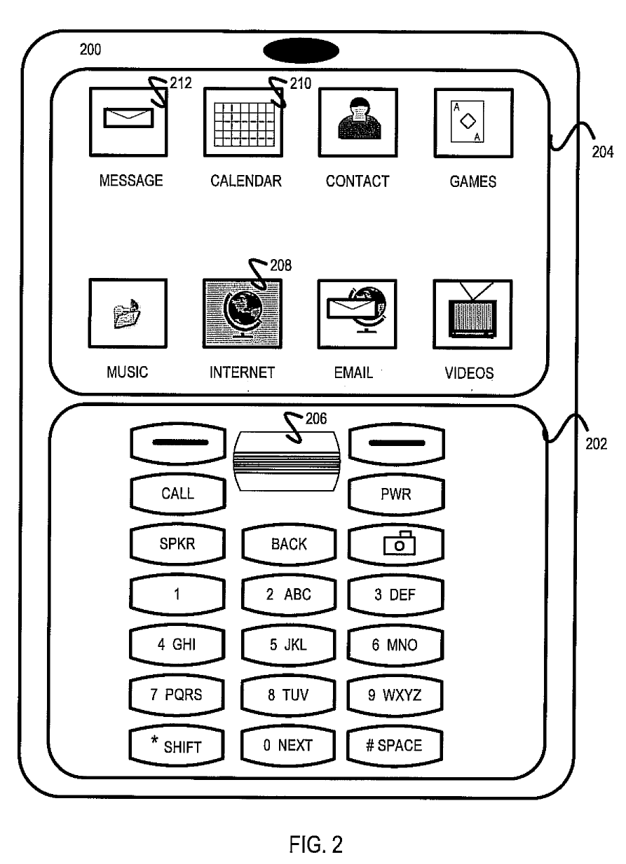

FIG. 2 shows, in an embodiment of the invention, a partial view of a mobile device 200, representing an example mobile device within which the inventive biometric scanning arrangement may be implemented. Mobile device 200 may include a keypad area 202 and a display area 204. Keypad area 202 may include alphanumeric keys and hotkeys.

In an embodiment, the biometric scanning arrangement may include a biometric sensor 206, which may be positioned within keypad area 202. The dimension of biometric sensor 206 may vary depending upon manufacturing preference. However, biometric sensor 206 has to be sufficiently large to capture a viable image of a unique physiological feature, such as a fingerprint.

Biometric sensor 206 may be employed as a navigation tool, in an embodiment. In other words, instead of also having a set of navigation keys to enable the user of the mobile device to maneuver through the various functions that may be available on the mobile device, biometric sensor 206 may be programmed to accept movements conducted across biometric sensor 206 to be navigation directions being provided to mobile device 200.

Consider the situation wherein, for example, a user of mobile device 200 wants to check incoming voice messages (which is stored by a message function 212). In order to move the cursor from an internet function 208 to message function 212, the user may swipe a finger in an upward direction. Biometric sensor 206, upon receiving the upward movement moves the cursor from internet function 208 to a calendar function 210. To move from calendar function 210 to message function 212, the user may swipe his finger in a left direction.

As can be appreciated from the foregoing, the implementation of biometric sensor 206 as a navigation tool, remove the necessity of including a set of navigation keys. Since both a set of navigational keys and a biometric sensor are not required, the redundancy of the set of navigational keys may be eliminated since the biometric sensor is able to be programmed to perform similar functions. As a result, the addition of biometric sensor 206 does not require the manufacturer to increase the size of the mobile device to accommodate the biometric sensor. Thus, the desirable small size of the mobile device is not negatively impacted with the additional feature of biometric sensor 206.

In addition, hardware failure may also be substantially reduced. In many mobile devices, the set of navigation keys experiences heavy usage. With the biometric sensor, the hardware fatigue that is usually associated with pressing a key over a period of time is significantly removed since controlling biometric sensor 206 to perform navigation does not require pressing a key.

Besides being employed as a navigation tool, biometric sensor 206 may also be employed to perform varied functions. The next few figures provide examples for implementing the biometric sensor in this capacity.

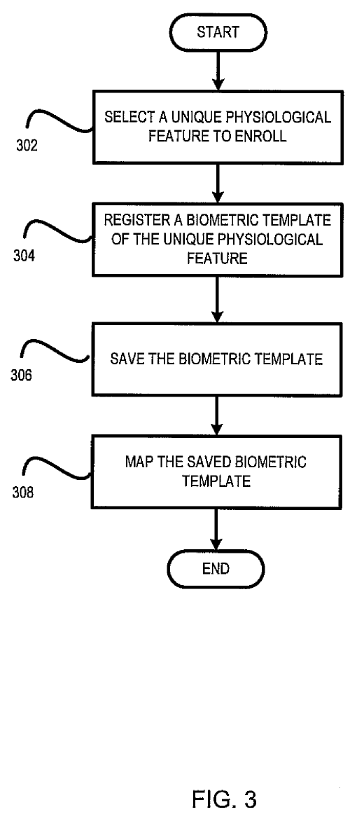

FIG. 3 shows, in an embodiment of the invention, a simple flow chart illustrating the steps for enrolling and mapping a unique physiological feature to one or more functions.

At a first step 302, a unique physiological feature is enrolled. Consider the situation wherein, for example, Matt, a user of mobile device 200, wants to protect his mobile device from unauthorized user. In an embodiment, security access is set up based on a unique physiological feature, such as a fingerprint of a specific finger or thumb. In an example, Matt set up his right thumb as the unique physiological feature that he will use to provide authentication data to the system of his mobile device.

At a next step 304, the enrollment occurs by registering a biometric template of the unique physiological feature. In an example, Matt swipes his right thumb across biometric sensor 206. In one embodiment, the unique physiological feature may have to be swiped across the biometric sensor in a predefined number of times in order to allow the biometric sensor time to capture and register the biometric template of the fingerprint. The predefined number of times may be a setting that may be controlled by the user. In an embodiment, the system of mobile device 200 may be an interactive system, providing feedback (such as displaying a message on display area 204 of mobile device 200), to the user. In an example, if biometric sensor is unable to record a clear biometric template of the print of the right thumb, feedback may be provided requesting the user to repeat the enrollment process.

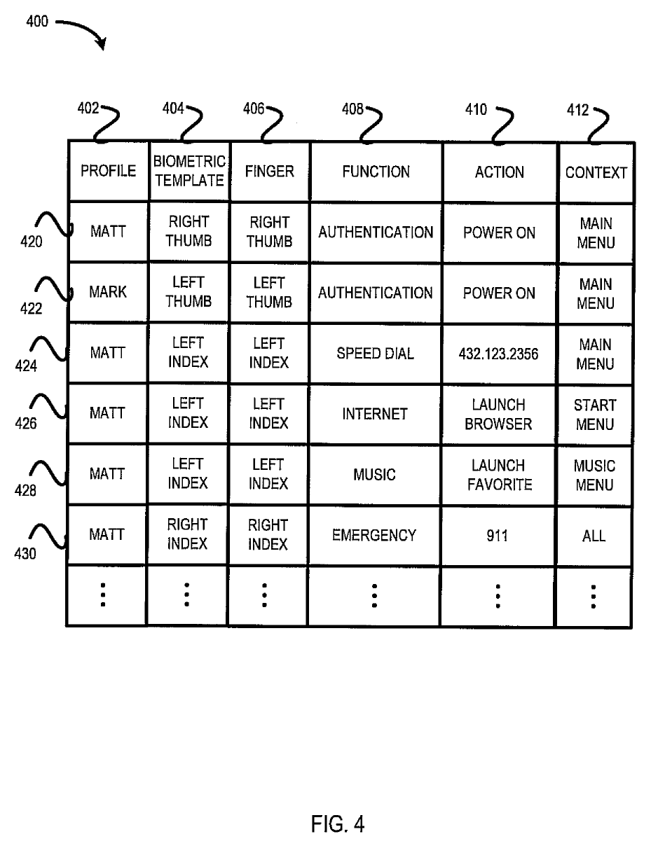

At a next step 306, the scanned pattern is saved as a biometric template. In an embodiment, biometric-related data, such as the biometric template of the right thumb print, is saved in a database 400 (shown in FIG. 4). In an example, row 420 shows that for Malt (data type profile 402), the biometric template of his right thumb (data type biometric template 404 and data type finger 406) has been stored.

In an embodiment, the enrollment process of steps 302 through 306 may be repeated if the user wants to enroll additional unique physiological features.

At a next step 308, the user may be prompted to map the biometric template to a function after the biometric template has been saved. In an embodiment, the user may be prompted upon enrolling a unique physiological feature. In another embodiment, the user may independently call another program to map the function to the saved biometric template(s).

To map a biometric template of a unique physiological feature to a function (which may include one or more action steps), the user may be given a list of functions that the user may choose from. In an example, Matt may choose to map the biometric template of his right thumb print to the authentication function (data type function 408).

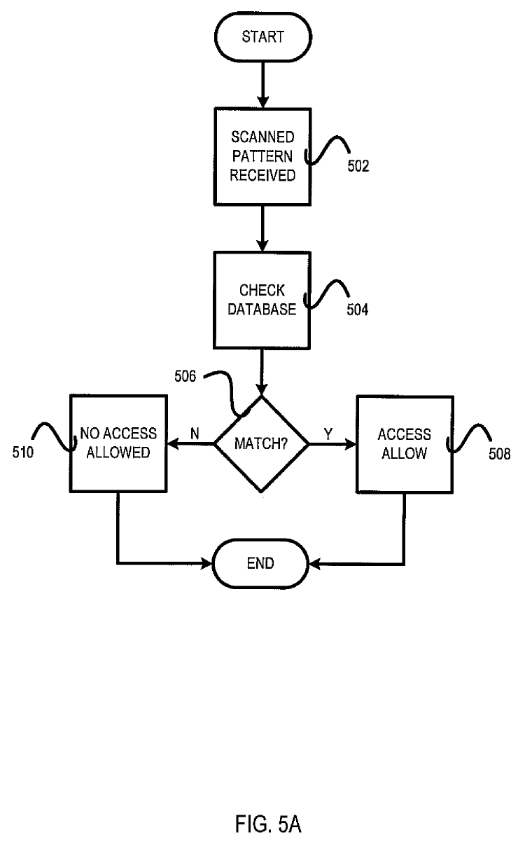

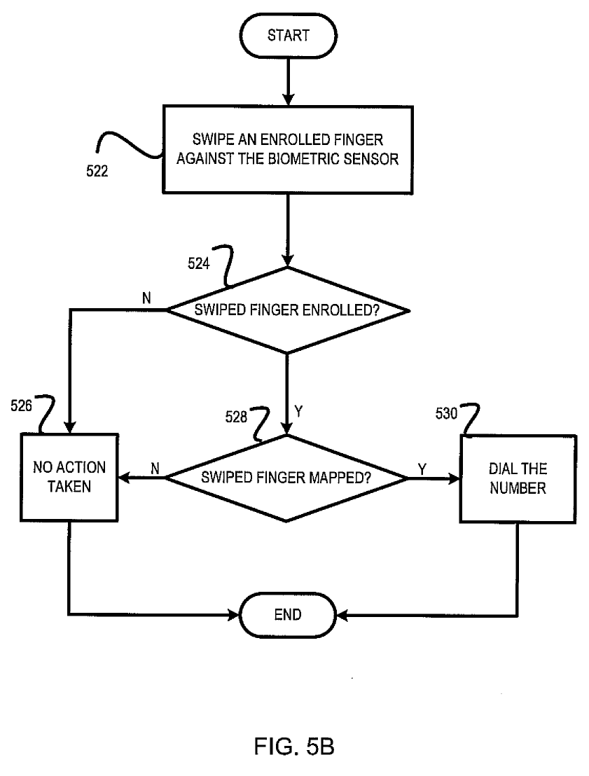

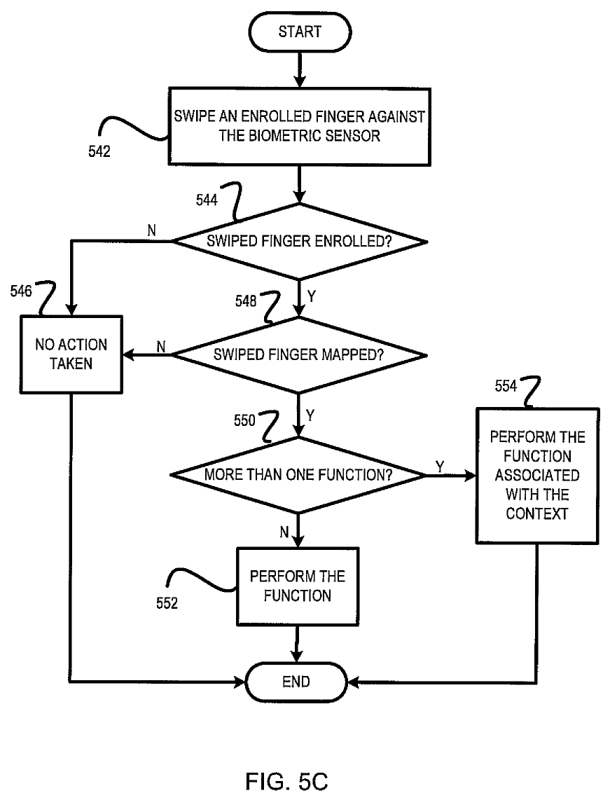

FIG. 5A shows, in an embodiment, a simple flow chart illustrating the steps to authenticate a user.

At a first step 502, a scanned pattern of a unique physiological feature is received. Consider the situation wherein, for example, Matt wants to access mobile device 200 (of FIG. 2). Matt may swipe his right thumb across biometric sensor 206.

At a next step 504, the system of mobile device 200 may check database 400 (FIG. 4) to verify the user. In the aforementioned example, Matt has mapped his right thumb print to the authentication function. To perform the match, the system of mobile device 200 may retrieve the saved biometric template (data type biometric template 404) associated with the authentication function (data type function 406) and compare the scanned pattern against the saved biometric template.

At a next step 506, the system of mobile device 200 may make a determination about the scanned pattern of the fingerprint in comparison to the saved biometric template. In an embodiment, an option is available for the system to set the match requirement (such as low, medium, and high) for comparison. In an example, if the match requirement is set to high, then the newly scanned pattern may have to closely resemble the saved biometric template

If a match is determined, then at a next step 508, the user is allowed access to mobile device 200. However, if a match is not determined, then at a next step 510, the user is prevented from accessing mobile device 200. In other words, once Matt has established the biometric template of the fingerprint of his right thumb as part of the authentication process, gaining access to mobile device 200 is limited to only the user with the fingerprint that matches the biometric template saved within database 400.

In an embodiment, more than one profile may be established to allow multiple users access to mobile device 200. If more than one user is associated with the mobile device, database 400 is configured to store a plurality of profiles, in an embodiment. In an example, besides Matt's profile (row 420), Mark has also established a profile (row 422) and has set up authentication data that will allow Mark to also access mobile device 200. Thus, with a biometric scanning arrangement, multiple users may gain access to a protected mobile device while unauthorized users are prevented from accessing mobile device 200.

Besides authenticating a user, the biometric scanning arrangement may also be implemented to activate other functions, such as speed dialing, launching the web browser, check messages, and the like.

FIG. 5B shows, in an embodiment of the invention, a simple flow chart illustrating the steps for performing speed dialing.

Similar to step 502, at a first step 522, the user may swipe his unique physiological feature, such as a finger, across a biometric sensor. Consider the situation wherein for example, Matt wants to dial his friend Charlie. Instead of dialing the number, looking the number up in a contact list, voice dialing, or pressing a key to perform speed dialing, Matt may swipe his left index finger across the biometric sensor.

At a next step 524, the system may make a determination if the unique physiological feature has been enrolled. In an example, the scanned pattern of Matt's left index finger is compared against a saved biometric template (row 424). If a match is not identified, then at a next step 526, no action is taken by the system. In an example, if a match is not identified, then the system may not perform the speed dialing. In an embodiment, the system may provide feedback to the user, thereby notifying the user the reason for the system lack of action.

However, if a match is identified, then at a next step 528, the system may make a determination if the saved biometric template has been mapped. If the saved biometric template has not been mapped to a function, then at step 526, no action is taken by the system. In an embodiment, the system may provide feedback to the user informing the user that no function has been defined for the saved biometric template.

However, if the saved biometric template has been mapped, then at a next step 530, the system may perform the function. In an example, Matt's biometric template of his left index finger has been mapped to Charlie's telephone number (row 424). As a result, upon validating a match, the system may automatically dial Charlie's telephone number (data type action 410).

In an embodiment of the invention, more than one function may be associated with a single physiological feature. FIG. 5C shows, in an embodiment of the invention, a simple flow chart illustrating the steps for handling situations under which more than one function may be associated with a single physiological feature.

Steps 542 through 548 are similar to steps 522 through steps 528 in that the system may receive a scanned pattern of a physiological feature after the user has activated the biometric sensor by presenting a unique physiological feature (e.g., swiping his finger). The scanned pattern is compared (544) against saved biometric templates stored within database 400. No action is performed by the system if a match is not identified (546). However, if a match is identified and the physiological feature has been mapped (548), then at a next step 550, the system may make a determination if more than one function has been mapped to the saved biometric template of the physiological feature.

If only one function has been mapped, then at a next step 552, the system of mobile device 200 may perform the function.

However, if more than one function has been mapped, then at a next step 554, the system of mobile device 200 may perform the function associated with the context In an example, rows 424, 426, and 428 are associated with the saved biometric template of the left index fingerprint. Since three functions (data type function 408 shows speed dial, internet, and music, respectively) have been associated with the saved biometric template, the system is configured to perform the action (data type action 410) associated with the context. In this example, the mobile device is currently in the main menu. Thus, the system of mobile device performs the speed dial function (as shown in row 424 of data type action 410) since the left index finger is associated with the speed dial function (data type function 408) in the main menu context (data type context 412).

In another example, Matt is currently within the music player. Within the music player, Matt is able to perform a plurality of actions (e.g., launch a specific song, launch a favorite folder, delete a file, and the like) related to the music player. If Matt swipes his left index finger while the music player is active, the only action that the system of mobile device 200 may perform is to launch the favorite folder (row 428). Thus, even though more than one function has been mapped to the left index finger, the system has an algorithm to determine which function is feasible according to the context.

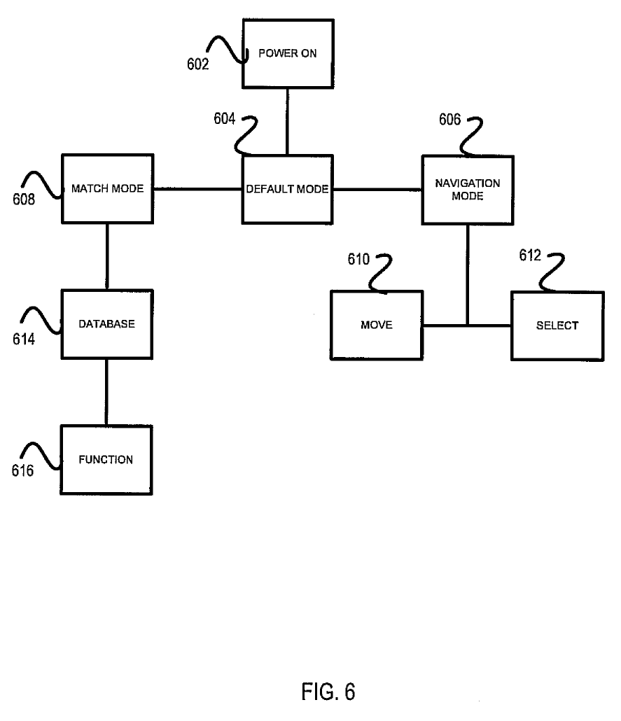

Since a user is able to utilize biometric sensor 206 to either navigate or to launch an application, the mobile device is programmed to move between the two modes. FIG. 6 shows, in an embodiment of the invention, a simple block diagram illustrating the mode status of a mobile device.

Consider the situation wherein, for example, Matt is powering on (602) his mobile device. When mobile device 200 is first powered on, mobile device may be set to a default mode (604). The default mode may either be a navigation mode (606) or a match mode (608). The default mode may be preset by the manufacturer, in an embodiment. In another embodiment, the default mode may be preset by the user of the mobile device.

If a user of a mobile device has not yet mapped a unique physiological feature to a function, then the system may automatically default to a navigation mode even if the default mode has been set to a match mode, in an embodiment. In other words, the system may check database 400 to determine if the user has mapped a unique physiological feature (besides the authentication mapping). If the system determines that no mapping exists, the system may default to a navigation mode.

As discussed herein, navigation mode refers to the mode under which biometric sensor 206 is configured to accept movement across biometric sensor 206 as instructions for manipulating a cursor (610) or making a selection (612). In navigation mode (606), biometric sensor 206 does not perform matching. Instead, biometric sensor 206 is configured to interpret the movements to determine how to manipulate the cursor. In other words, during the navigation mode, regardless of the unique physiological feature (e.g., right thumb, left index finger, etc.) that may be employed, the biometric sensor is configured to only read the direction of the movements to manipulate the cursor movement and/or perform a selection on an item displayed on the display screen.

As discussed herein, match mode refers to the mode under which biometric sensor 206 is configured to perform a scan of a unique physiological feature (such as a fingerprint) and to compare the scanned pattern against a saved biometric template stored within a database to determine the function to perform in match mode (608), biometric sensor 206 does not perform navigation. Instead biometric sensor 206 is configured to match a scanned pattern of a fingerprint, for example, against a database (614) of biometric templates. If a successful matching occurs, then a success status, for example, may be sent to the application, which is configured to perform the function (616) associated with the unique physiological feature upon receiving a success status.

Since both modes are supported by the biometric scanning arrangement, the system is configured to enable a user to switch between the two modes. In an embodiment, the user may press a switch button to switch between modes. In another embodiment, the user may launch a switch mode function to perform the switch. In an example, if mobile device 200 is in a navigation mode, the user may employ biometric sensor 206 to navigate to a switch mode function to perform the switch. In another example, if mobile device 200 is in a match mode, the user may map one of the unique physiological features to launch the switch mode function. As can be appreciated from the foregoing, the methods for performing the switch may vary and the examples discussed are not meant as a limitation to the invention.

In an embodiment, the match mode is a temporary mode. In an example, the system of the mobile device may switch over to a navigation mode if the mobile device is inactive for a predefined period of time. By setting the match mode as a temporary mode, unintentional function call is prevented.

In an embodiment, the system of the mobile device default to a match mode when the mobile device is either powered off or is in sleep mode. To access the mobile device when the mobile device is first powered on, the unique physiological feature associated with authentication may have to be matched against the database of biometric patterns saved to allow the user access to the mobile device.

In an embodiment, the mobile device is configured to perform the emergency function associated with a unique physiological feature regardless of the status of the mobile device. In an example, Matt needs to make an emergency call. To make the call, Matt swipes his right index finger across biometric sensor 206. Upon receiving the scanned pattern, the biometric scanning arrangement compares the scanned pattern against database 400. If the scanned pattern matches the saved biometric template associated with the emergency function, the system wakes up mobile device 200 and dials the emergency number. As can be appreciated from the foregoing, emergency calls can now be made without first having to unlock the mobile device or waking up the mobile device. This method allows emergency to be handled in a timely manner without requiring the user to undergo a series of steps to make an emergency call, especially when time is of the essence.

In this document various implementations have been discussed using mobile telephones as an example. This invention, however, is not limited to mobile telephones and may be applied to any electronic devices that may be integrated with a biometric sensor (such as a personal digital assistant, tablet, game system, global positioning system, laptop, digital telephone, and the like). Instead, the discussions are meant as examples and the invention is not limited by the examples presented.

In an example, the biometric scanning arrangement may be implemented as part of a game system. In a game system, the player is provided with navigation buttons to enable the player to maneuver through the game. In an embodiment, a biometric sensor may replace the set of navigation buttons. Similar to the aforementioned embodiments, the biometric sensor may be utilized as a navigation tool. In an example, to maneuver a character through the game, the player may swipe his finger across the biometric sensor to direct the movement of the player. In another example, to launch a menu item, the player may map his unique physiological features to one or more menu functions. For example, the player may have previously mapped his right ring finger to the weapon list. Thus, during the game, the player may swipe his right ring finger across the biometric sensor to bring up the list of weapons a player may have collected. Since the player is not required to continually press buttons to play the game, hardware fatigue (that may be associated with pressing buttons) and physical fatigue (that may be experienced by the player) may be substantially eliminated. The above example is a simple example of how the biometric scanning arrangement may be implemented within other electronic devices beside the mobile telephone.

As can be appreciated from the forgoing, one or more embodiments of the present invention provide for a biometric scanning arrangement that add functions to a mobile device without having to change the mobile device form. With the biometric scanning arrangement, the owner of the mobile device is provided security against unauthorized users. Since the biometric scanning arrangement is programmable, the biometric scanning arrangement may provide functions (e.g., navigation, launching software application, and the like) that may have previously been performed by other keys, thereby enabling the manufacturer to offer additional functions within a desirable physical form.

While this invention has been described in terms of several preferred embodiments, there are alterations, permutations, and equivalents, which fall within the scope of this invention. Although various examples are provided herein, it is intended that these examples be illustrative and not limiting with respect to the invention.

Also, the title and summary are provided herein for convenience and should not be used to construe the scope of the claims herein. Further, the abstract is written in a highly abbreviated form and is provided herein for convenience and thus should not be employed to construe or limit the overall invention, which is expressed in the claims. If the term “set” is employed herein, such term is intended to have its commonly understood mathematical meaning to cover zero, one, or more than one member. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A method for employing a biometric scanning arrangement to manage a set of actions performed on a mobile device, comprising:
setting said biometric scanning arrangement to a mode, wherein said mode including at least one of a navigation mode and a matching mode;
capturing an image of a unique physiological feature, wherein said capturing is performed by a biometric sensor; and
performing said set of actions associated with said image for said mode, wherein said set of actions is other than authentication of a user possessing said unique physiological feature.

2. The method of claim 1 further including enrolling a set of unique physiological features, wherein said enrolling includes
receiving a first image of a first unique physiological feature of said set of unique physiological features by said biometric sensor when said first unique physiological feature is provided to said biometric sensor, wherein said first image is a biometric template of said first unique physiological feature, saving said first image to a database, wherein said database is configured to stored biometric-related data, and mapping said first image to a first function call, wherein said first function call is associated with one or more actions of said set of actions, wherein said mapping is performed when said user of said mobile device designates said first function call to said first image, and
receiving a second image of a second unique physiological feature of said set of unique physiological features when said second unique physiological feature is presented to said biometric sensor, wherein said second image is a biometric template of said second unique physiological feature, saving said second image to said database, and mapping said second image to a second function call.

3. The method of claim 2 wherein said biometric scanning arrangement includes performing said first function call when said biometric scanning arrangement receives said image captured by said biometric sensor, wherein said image matches said first image stored in said database.

4. The method of claim 3 wherein a context is assigned to each function call when said image is associated with at least two function calls, wherein said context is employed by said mobile device to determine which function call of said at least two function calls to perform.

5. The method of claim 1 further including
comparing said image captured by said biometric sensor against a database; and
performing said set of actions associated with said image if said set of actions pertains to an emergency function, even if said mobile device keypad is locked.

6. The method of claim 1 wherein said biometric scanning arrangement is set to a default mode when said mobile device is first initiated, wherein said default mode is said one of said navigation mode and said match mode.

7. The method of claim 6 wherein said default mode is preset by said user of said mobile device.

8. The method of claim 1 wherein said mode of said biometric scanning arrangement is set to said navigation mode, wherein said biometric scanning arrangement is configured for
receiving said image when said unique physiological feature is swiped across said biometric sensor, and
interpreting said image as instruction for navigating a cursor of said mobile device.

9. The method of claim 1 wherein said mobile device is a mobile telephone.

10. A biometric scanning arrangement within a mobile device, comprising:
a biometric sensor, said biometric sensor is configured to sense a unique physiological feature when said unique physiological feature is presented to said biometric sensor; and
a database for storing biometric-related data, wherein said database is configured to include a set of saved images, wherein said set of saved images are biometric templates of a set of unique physiological features, wherein said set of saved images is mapped to a set of actions, wherein said set of actions exclude authentication of a user possessing said unique physiological feature.

11. The biometric scanning arrangement of claim 10 wherein said biometric sensor is configured to capture an image of said unique physiological feature, wherein said image is matched against said set of saved images stored in said database, wherein if said image matches with a saved image of said set of saved images, a function call mapped to said saved image is performed.

12. The biometric scanning arrangement of claim 10 wherein said biometric sensor is configured to capture an image of said unique physiological feature, wherein said biometric scanning arrangement is configured to interpret said image as instruction for navigating a cursor of said mobile device.

13. The biometric scanning arrangement of claim 10 wherein said database is configured to store a set of profiles, wherein said set of profiles is associated with a set of users of said mobile device.

14. The biometric scanning arrangement of claim 10 wherein said database is configured to store a context for each function call of said set of function calls, wherein said mobile device is configured to employ said context to determine which function call of said set of function calls to perform when a saved image is associated with at least two function calls.

15. An article of manufacture comprising a program storage medium having computer readable code embodied therein, said computer readable code being configured for employing a biometric scanning arrangement to manage a set of actions performed on a mobile device, comprising:
code for setting said biometric scanning arrangement to a mode, wherein said mode including at least one of a navigation mode and a matching mode;
code for capturing an image of a unique physiological feature, wherein said code for capturing is performed by a biometric sensor; and
code for performing said set of actions associated with said image for said mode, wherein said set of actions is other than authentication of a user possessing said unique physiological feature.

16. The article of manufacture of claim 15 further including code for enrolling a set of unique physiological features, wherein said code for enrolling includes
code for receiving a first image of a first unique physiological feature of said set of unique physiological features by said biometric sensor when said first unique physiological feature is provided to said biometric sensor, wherein said first image is a biometric template of said first unique physiological feature, code for saving said first image to a database, wherein said database is configured to stored biometric-related data, and code for mapping said first image to a first function call, wherein said first function call is associated with one or more actions of said set of actions, wherein said code for mapping is performed when said user of said mobile device designates said first function call to said first image, and
code for receiving a second image of a second unique physiological feature of said set of unique physiological features when said second unique physiological feature is provided to said biometric sensor, wherein said second image is a biometric template of said second unique physiological feature, code for saving said second image to said database, and code for mapping said second image to a second function call.

17. The article of manufacture of claim 16 wherein said biometric scanning arrangement includes code for performing said first function call when said biometric scanning arrangement receives said image captured by said biometric sensor, wherein said image matches said first image stored within said database.

18. The article of manufacture of claim 17 wherein a context is assigned to each function call when said image is associated with at least two function calls, wherein said context is employed by said mobile device to determine which function call of said at least two function calls to perform.

19. The article of manufacture of claim 15 further including
code for comparing said image captured by said biometric sensor against a database; and
code for performing said set of actions associated with said image if said set of actions pertains to an emergency function, even if said mobile device keypad is locked.

20. The article of manufacture of claim 15 wherein said mode of said biometric scanning arrangement is set to said navigation mode, wherein said biometric scanning arrangement includes
code for receiving said image when said unique physiological feature is swiped across said biometric sensor, and
code for interpreting said image as instruction for navigating a cursor of said mobile device.
